SEQUENCE LISTING (4 sequences)

SEQ ID NO: 1 - DNA, 20 bp, Artificial Sequence
  Synthetic sequence
ccatctgttgcgtgcgtgtc

SEQ ID NO: 2 - DNA, 20 bp, Artificial Sequence
  Synthetic sequence
cgtttcccctgtgtgccttg

SEQ ID NO: 3 - DNA, 40 bp, Artificial Sequence
  Synthetic sequence
cgtttcccctgtgtgccttgccatctgttccctccctgtc

SEQ ID NO: 4 - DNA, 15 bp, Artificial Sequence
  Synthetic sequence
gcctccctcgcgcca

(19) United States
(12) Patent Application Publication
(10) Pub. No.: US 2013/0109576 A1
(43) Pub. Date: May 2, 2013

(54) METHODS FOR DETECTING MUTATIONS

(71) Applicants: Anthony P. Shuber, Mendon, MA (US); Cecilia Fernandez, Jamaica Plain, MA (US)

(72) Inventors: Anthony P. Shuber, Mendon, MA (US); Cecilia Fernandez, Jamaica Plain, MA (US)

(21) Appl. No.: 13/661,666

(22) Filed: Oct. 26, 2012

Related U.S. Application Data
(60) Provisional application No. 61/552,945, filed on Oct. 28, 2011.

(51) Int. Cl. C40B 20/00

(52) U.S. Cl. 506/2

(57) ABSTRACT

The invention generally relates to methods for detecting mutations in a nucleic acid. In certain embodiments, the invention provides methods that involve forming a plurality of droplets, such that on average, each droplet includes a ratio of one nucleic acid template per bead, amplifying the template in the droplet to produce bead-bound amplicons, and sequencing at least one amplicon detect a mutation.

### RELATED APPLICATION

The present application claims the benefit of and priority to U.S. provisional application Ser. No. 61/552,945, filed Oct. 28, 2011, the content of which is incorporated by reference herein in its entirety.

### FIELD OF THE INVENTION

The invention generally relates to methods for detecting mutations in a nucleic acid.

### BACKGROUND

Next generation sequencing has fundamentally altered genomic research and is generally being used to analyze nucleic acid molecules from bodily fluids for the presence of mutations, thus leading to early diagnosis of certain diseases such as cancer. In a typical bodily fluid sample however, a majority of the nucleic acid is degraded, and any altered nucleic acids containing mutations of interest are present in small amounts (e.g., less than 1%) relative to a total amount of nucleic acids in the bodily fluid sample. This can result in a failure to detect the small amount of abnormal nucleic acid during the sequencing reaction.

In order to detect abnormal nucleic acids in the sample during the sequencing reaction, an amplification reaction typically is conducted prior to sequencing. However, due to the stochastic nature of the amplification reaction, a population of molecules that is present in a small amount in the sample often is overlooked. In fact, if rare nucleic acid is not amplified in the first few rounds of amplification, it becomes increasingly unlikely that the rare event will ever be detected during the sequencing reaction. Thus, the resulting biased post-amplification nucleic acid population does not represent the true condition of the sample from which it was obtained.

### SUMMARY

The invention generally relates to methods for detecting an abnormal nucleic acid from a sample. The invention goes beyond simply sequencing total nucleic acid in a sample, and instead provides sample preparation techniques that promote representation of all nucleic acid populations (e.g., normal and mutated) in the sequencing reaction. In essence, methods of the invention allow for the detection of small populations of abnormal nucleic acid in a heterogeneous sample. For example, methods of the invention can reproducibly detect a mutation present in as little as about 0.01% of the copies of a gene.

In certain aspects, methods of the invention involve forming a plurality of droplets, such that on average, each droplet includes a ratio of one nucleic acid template per bead, amplifying the template in the droplet to produce bead-bound amplicons, and sequencing at least one amplicon to detect a mutation. In this manner, methods of the invention avoid problems associated with having too much template DNA bound to each bead, which can interfere with successful detection of a rare nucleic acid during a sequencing reactions. Methods of the invention avoid this problem by attenuating the amount of template amplification product that is bound to each bead.

Any technique known in the art for forming sample droplets may be used with methods of the invention. An exemplary method involves flowing a stream of sample fluid including nucleic acids such that it intersects two opposing streams of a flowing fluid that is immiscible with the sample fluid. Intersection of the sample fluid with the two opposing streams of the flowing immiscible fluid results in partitioning of the sample fluid into individual sample droplets. The immiscible fluid may be any fluid that is immiscible with the sample fluid. An exemplary immiscible fluid is oil. In certain embodiments, the immiscible fluid includes a surfactant, such as a fluorosurfactant.

The nucleic acids are then amplified in the droplets. Any method known in the art may be used to amplify the nucleic acids. A preferred method is the polymerase chain reaction (PCR). In particular embodiments, the amplification reaction is conducted with a limiting amount of amplification primers, thereby decreasing an overall amount of amplicon that binds to an individual bead during the amplification reaction. In other embodiments, a heat denaturation step (e.g., 94° C. 2 minutes, 4° C. hold) is conducted prior to annealing of the PCR amplification primer.

After completion of the amplification reaction, the droplets may be ruptured, releasing the contents of the droplets. In certain embodiments, the bead-bound amplicons are separated from remaining components of the droplets (i.e., enrichment of the bead-bound amplicons) prior to the sequencing reaction. Sequencing may be by any method known in the art. Sequencing-by-synthesis is a common technique used in next generation procedures and works well with the instant invention. However, other sequencing methods can be used, including sequence-by-ligation, sequencing-by-hybridization; gel-based techniques and others. In general, sequencing involves hybridizing a primer to a template to form a template/primer duplex, contacting the duplex with a polymerase in the presence of a detectably-labeled nucleotides under conditions that permit the polymerase to add nucleotides to the primer in a template-dependent manner. Signal from the detectable label is then used to identify the incorporated base and the steps are sequentially repeated in order to determine the linear order of nucleotides in the template. Exemplary detectable labels include radiolabels, florescent labels, enzymatic labels, etc. In particular embodiments, the detectable label may be an optically detectable label, such as a fluorescent label. Exemplary fluorescent labels include cyanine, rhodamine, fluorescien, coumarin, BODIPY, alexa, or conjugated multi-dyes.

Numerous techniques are known for detecting sequence and for identifying barcodes and some are exemplified below. However, the exact means for detecting and compiling sequence data does not affect the function of the invention described herein.

Methods of the invention may involve conducting an initial amplification reaction on the nucleic acids from the sample prior to forming the droplets that include the nucleic acids. This initial amplification step may be used to attach a bar code sequence to the nucleic acids in the sample. Attaching bar codes to nucleic acids in a sample allows for sample multiplexing and allows multiple samples to be analyzing in a single sequencing reaction.

In certain embodiments, the method is performed in the presence of a control genomic DNA. In other embodiments, the method is performed in the presence of an artificially introduced amount of nucleic acid comprising a known mutation.

Another aspect of the invention provides methods for detecting a mutation in a nucleic acid that involve performing an amplification reaction in a plurality of droplets, each droplet comprising nucleic acid templates and beads, wherein the template to bead ratio is such that less than 2% of the beads comprise more than one template after completion of the amplification reaction, and sequencing at least one amplification product to detect a mutation.

### DETAILED DESCRIPTION

The invention generally relates to methods of detecting a mutation in a nucleic acid. In certain aspects, methods of the invention involve forming a plurality of droplets, such that on average, each droplet includes a ratio of one nucleic acid template per bead, amplifying the template in the droplet to produce bead-bound amplicons, and sequencing at least one amplicon to detect a mutation.

### Obtaining a Sample

Methods of the invention may involve obtaining a sample, such as an environmental or biological sample, that is suspected to contain a nucleic acid including a mutation. Exemplary samples include blood, saliva, sputum, urine, stool, sweat, biopsy tissue, as well as tissue from brain, kidney, liver, pancreas, bone, skin, eye, muscle, intestine, ovary, prostate, vagina, cervix, uterus, esophagus, stomach, bone marrow, and lymph node. The sample may be obtained by methods known in the art, such as fine needle aspiration, core needle biopsy, vacuum assisted biopsy, direct and frontal lobe biopsy, shave biopsy, punch biopsy, excisional biopsy, or cutterage biopsy. One of skill in the art will recognize that methods and systems of the invention are not limited to any particular type of sample, and methods and systems of the invention may be used with any type of organic, inorganic, or biological molecule.

In one embodiment, nucleic acid molecules are isolated from a biological sample containing a variety of other components, such as proteins, lipids and non-template nucleic acids. Nucleic acid target molecules can be obtained from any cellular material, obtained from an animal, plant, bacterium, fungus, or any other cellular organism. In certain embodiments, the nucleic acid target molecules are obtained from a single cell. Biological samples for use in the present invention include viral particles or preparations. Nucleic acid target molecules can be obtained directly from an organism or from a biological sample obtained from an organism, e.g., from blood, urine, cerebrospinal fluid, seminal fluid, saliva, sputum, stool and tissue. Any tissue or body fluid specimen may be used as a source for nucleic acid for use in the invention. Nucleic acid target molecules can also be isolated from cultured cells, such as a primary cell culture or a cell line. The cells or tissues from which target nucleic acids are obtained can be infected with a virus or other intracellular pathogen. A sample can also be total RNA extracted from a biological specimen, a cDNA library, viral, or genomic DNA.

### Extraction

It may be necessary to first prepare an extract of the cell and then perform further steps—i.e., differential precipitation, column chromatography, extraction with organic solvents and the like—in order to obtain a sufficiently pure preparation of nucleic acid. Extracts may be prepared using standard techniques in the art, for example, by chemical or mechanical lysis of the cell. Extracts then may be further treated, for example, by filtration and/or centrifugation and/or with chaotropic salts such as guanidinium isothiocyanate or urea or with organic solvents such as phenol and/or HCCl₃ to denature any contaminating and potentially interfering proteins.

Generally, nucleic acid can be extracted from a biological sample by a variety of techniques such as those described by Maniatis, et al., Molecular Cloning: A Laboratory Manual, Cold Spring Harbor, N.Y., pp. 280-281 (1982), the contents of which is incorporated by reference herein in its entirety. Nucleic acid molecules may be single-stranded, double-stranded, or double-stranded with single-stranded regions (for example, stem- and loop-structures).

Nucleic acid obtained from biological samples typically is fragmented to produce suitable fragments for analysis. Target nucleic acids may be fragmented or sheared to desired length, using a variety of mechanical, chemical and/or enzymatic methods. DNA may be randomly sheared via sonication, e.g. Covaris method, brief exposure to a DNase, or using a mixture of one or more restriction enzymes, or a transposase or nicking enzyme. RNA may be fragmented by brief exposure to an RNase, heat plus magnesium, or by shearing. The RNA may be converted to cDNA. If fragmentation is employed, the RNA may be converted to cDNA before or after fragmentation. In one embodiment, nucleic acid from a biological sample is fragmented by sonication. In another embodiment, nucleic acid is fragmented by a hydroshear instrument. Generally, individual nucleic acid target molecules can be from about 40 bases to about 40 kb. Nucleic acid molecules may be single-stranded, double-stranded, or double-stranded with single-stranded regions (for example, stem- and loop-structures).

A biological sample as described herein may be homogenized or fractionated in the presence of a detergent or surfactant. The concentration of the detergent in the buffer may be about 0.05% to about 10.0%. The concentration of the detergent can be up to an amount where the detergent remains soluble in the solution. In one embodiment, the concentration of the detergent is between 0.1% to about 2%. The detergent, particularly a mild one that is nondenaturing, can act to solubilize the sample. Detergents may be ionic or nonionic. Examples of nonionic detergents include triton, such as the Triton® X series (Triton® X-100 t-Oct-C₆H₄—(OCH₂—CH₂)ₓOH, x=9-10, Triton® X-100R, Triton® X-114 x=7-8), octyl glucoside, polyoxyethylene(9)dodecyl ether, digitonin, IGEPAL® CA630 octylphenyl polyethylene glycol, n-octyl-beta-D-glucopyranoside (betaOG), n-dodecyl-beta, Tween® 20 polyethylene glycol sorbitan monolaurate, Tween® 80 polyethylene glycol sorbitan monooleate, polidocanol, n-dodecyl beta-D-maltoside (DDM), NP-40 nonylphenyl polyethylene glycol, C12E8 (octaethylene glycol n-dodecyl monoether), hexaethyleneglycol mono-n-tetradecyl ether (C14E06), octyl-beta-thioglucopyranoside (octyl thioglucoside, OTG), Emulgen, and polyoxyethylene 10 lauryl ether (C12E10). Examples of ionic detergents (anionic or cationic) include deoxycholate, sodium dodecyl sulfate (SDS), N-lauroylsarcosine, and cetyltrimethylammoniumbromide (CTAB). A zwitterionic reagent may also be used in the purification schemes of the present invention, such as Chaps, zwitterion 3-14, and 3-[(3-cholamidopropyl)dimethylammonio]-1-propanesulf-onate. It is contemplated also that urea may be added with or without another detergent or surfactant.

Lysis or homogenization solutions may further contain other agents, such as reducing agents. Examples of such reducing agents include dithiothreitol (DTT), .beta.-mercaptoethanol, DTE, GSH, cysteine, cysteamine, tricarboxyethyl phosphine (TCEP), or salts of sulfurous acid.

Size selection of the nucleic acids may be performed to remove very short fragments or very long fragments. The nucleic acid fragments can be partitioned into fractions comprising a desired number of fragments using any suitable method known in the art. Suitable methods to limit the fragment size in each fragment are known in the art. In various embodiments of the invention, the fragment size is limited to between about 10 and about 100 Kb or longer.

### Primary Amplification to Produce Template DNA

The template nucleic acid can be constructed from any source of nucleic acid, e.g., any cell, tissue, or organism, and can be generated by any art-recognized method. Alternatively, template libraries can be made by generating a complementary DNA (cDNA) library from RNA, e.g., messenger RNA (mRNA). Methods of sample preparation may be found in U.S. application Ser. No. 10/767,779 and PCT application US04/02570 and is also published in WO/04070007—all incorporated herein by reference in their entirety.

One preferred method of nucleic acid template preparation is to perform PCR on a sample to amplify a region containing the allele or alleles of interest. The PCR technique can be applied to any nucleic acid sample (DNA, RNA, cDNA) using oligonucleotide primers spaced apart from each other. The primers are complementary to opposite strands of a double stranded DNA molecule and are typically separated by from about 50 to 450 nucleotides or more (usually not more than 2000 nucleotides). The PCR method is described in a number of publications, including Saiki et al., Science (1985) 230:1350-1354; Saiki et al., Nature (1986) 324:163-166; and Scharf et al., Science (1986) 233:1076-1078. Also see U.S. Pat. Nos. 4,683,194; 4,683,195; and 4,683,202, the text of each patent is herein incorporated by reference. Additional methods for PCR amplification are described in: PCR Technology: Principles and Applications for DNA Amplification ed. HA Erlich, Freeman Press, New York, N.Y. (1992); PCR Protocols: A Guide to Methods and Applications, eds. Innis, Gelfland, Snisky, and White, Academic Press, San Diego, Calif. (1990); Mattila et al. (1991) Nucleic Acids Res. 19: 4967; Eckert, K. A. and Kunkel, T. A. (1991) PCR Methods and Applications 1: 17, and; PCR, eds. McPherson, Quirkes, and Taylor, IRL Press, Oxford, which are incorporated herein by reference.

In certain embodiments, the primary PCR step is carried out using chimeric primers containing a sequence specific portion for amplifying a target of interest along with adapter sequences required for sequencing analysis. The forward primer (Primer A-Key) includes, in the 5′ to 3′ direction, a sequencing primer, a library key (such as TCAG), a multiplex ID barcode (MID), and a template specific sequence. The reverse primer includes, in the 5′ to 3′ direction, an emPCR capture site, a library key (TCAG), a MID barcode, and a template specific sequence.

Multiple samples can be incorporated into a single sequencing run by using primers with a unique multiplex ID barcode (“MID”) for each individual.

### Target Identifiers or Barcodes

In some embodiments, a primer can include an identifier molecule to function as a target identifier. The target identifier molecule may be any molecule that is differentially detectable by any detection techniques known in the art. In some embodiments, the target identifier is a unique multiplex ID barcode (“MID”), detectable by sequencing methods. Other exemplary detection methods for target identifiers include radioactive detection, optical absorbance detection, e.g., UV-visible absorbance detection, optical emission detection, e.g., fluorescence; phosphorescence or chemiluminescence; Raman scattering, magnetic detection, or mass spectral detection. In certain embodiments, the identifier is an optically detectable label, such as a fluorescent label. Examples of fluorescent labels include, but are not limited to, 4-acetamido-4′-isothiocyanatostilbene-2,2′ disulfonic acid; acridine and derivatives: acridine, acridine isothiocyanate; 5-(2′-aminoethyl)aminonaphthalene-1-sulfonic acid (EDANS); 4-amino-N-[3-vinylsulfonyl)phenyl]naphthalimide-3,5 disulfonate; N-(4-anilino-1-naphthyl)maleimide; anthranilamide; BODIPY; Brilliant Yellow; coumarin and derivatives; coumarin, 7-amino-4-methylcoumarin (AMC, Coumarin 120), 7-amino-4-trifluoromethylcouluarin (Coumaran 151); cyanine dyes; cyanosine; 4′,6-diaminidino-2-phenylindole (DAPI); 5′5″-dibromopyrogallol-sulfonaphthalein (Bromopyrogallol Red); 7-diethylamino-3-(4′-isothiocyanatophenyl)-4-methylcoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylamino]naphthalene-1-sulfonyl chloride (DNS, dansylchloride); 4-dimethylaminophenylazophenyl-4′-isothiocyanate (DABITC); eosin and derivatives; eosin, eosin isothiocyanate, erythrosin and derivatives; erythrosin B, erythrosin, isothiocyanate; ethidium; fluorescein and derivatives; 5-carboxyfluorescein (FAM), 5-(4,6-dichlorotriazin-2-yl)aminofluorescein (DTAF), 2′,7′-dimethoxy-4′5′-dichloro-6-carboxyfluorescein, fluorescein, fluorescein isothiocyanate, QFITC, (XRITC); fluorescamine; IR144; IR1446; Malachite Green isothiocyanate; 4-methylumbelliferoneortho cresolphthalein; nitrotyrosine; pararosaniline; Phenol Red; B-phycoerythrin; o-phthaldialdehyde; pyrene and derivatives: pyrene, pyrene butyrate, succinimidyl 1-pyrene; butyrate quantum dots; Reactive Red 4 (Cibacron™ Brilliant Red 3B-A) rhodamine and derivatives: 6-carboxy-X-rhodamine (ROX), 6-carboxyrhodamine (R6G), lissamine rhodamine B sulfonyl chloride rhodamine (Rhod), rhodamine B, rhodamine 123, rhodamine X isothiocyanate, sulforhodamine B, sulforhodamine 101, sulfonyl chloride derivative of sulforhodamine 101 (Texas Red); N,N,N′,N′ tetramethyl-6-carboxyrhodamine (TAMRA); tetramethyl rhodamine; tetramethyl rhodamine isothiocyanate (TRITC); riboflavin; rosolic acid; terbium chelate derivatives; Atto dyes, Cy3; Cy5; Cy5.5; Cy7; IRD 700; IRD 800; La Jolta Blue; phthalo cyanine; and naphthalo cyanine. Preferred fluorescent labels are cyanine-3 and cyanine-5. Labels other than fluorescent labels are contemplated by the invention, including other optically-detectable labels.

Fluorescently labeled nucleotides may be produced by various techniques, such as those described in Kambara et al. (Bio/Technol., 6:816-21, 1988); Smith et al. (Nucl. Acid Res., 13:2399-2412, 1985); and Smith et al. (Nature, 321: 674-679, 1986). The fluorescent dye may be linked to the deoxyribose by a linker arm that is easily cleaved by chemical or enzymatic means. There are numerous linkers and methods for attaching labels to nucleotides, as shown in Oligonucleotides and Analogues: A Practical Approach (IRL Press, Oxford, 1991); Zuckerman et al. (Polynucleotides Res., 15: 5305-5321, 1987); Sharma et al. (Polynucleotides Res., 19:3019, 1991); Giusti et al. (PCR Methods and Applications, 2:223-227, 1993); Fung et al. (U.S. Pat. No. 4,757,141); Stabinsky (U.S. Pat. No. 4,739,044); Agrawal et al. (Tetrahedron Letters, 31:1543-1546, 1990); Sproat et al. (Polynucleotides Res., 15:4837, 1987); and Nelson et al. (Polynucleotides Res., 17:7187-7194, 1989). Extensive guidance exists in the literature for derivatizing fluorophore and quencher molecules for covalent attachment via common reactive groups that may be added to a nucleotide. Many linking moieties and methods for attaching fluorophore moieties to nucleotides also exist, as described in Oligonucleotides and Analogues, supra; Guisti et al., supra; Agrawal et al, supra; and Sproat et al., supra.

In a preferred embodiment, the target identifier is a sequence of oligonucleotides that constitutes a unique identifier, or barcode. An exemplary barcode is an MID. Attaching barcode sequences to other molecules, such as nucleic acids, is shown for example in Kahvejian et al. (U.S. patent application number 2008/0081330), and Steinman et al. (International patent application number PCT/US09/64001), the content of each of which is incorporated by reference herein in its entirety. Methods for designing sets of barcode sequences and other methods for attaching barcode sequences are shown in U.S. Pat. Nos. 6,138,077; 6,352,828; 5,636,400; 6,172,214; 6235,475; 7,393,665; 7,544,473; 5,846,719; 5,695,934; 5,604,097; 6,150,516; RE39,793; 7,537,897; 6,172,218; and 5,863,722, the content of each of which is incorporated by reference herein in its entirety. In certain embodiments, a single barcode is attached to each identifier. In other embodiments, a plurality of barcodes, e.g., two barcodes, are attached to each identifier.

In certain embodiments, the barcode identifier can include features that make it useful in nucleic acid sequencing reactions. For example the barcode sequences are designed to have minimal or no homopolymer regions, i.e., 2 or more of the same base in a row such as AA or CCC, within the barcode sequence.

Methods of designing sets of nucleic acid barcode sequences is shown for example in Brenner et al. (U.S. Pat. No. 6,235,475), the contents of which are incorporated by reference herein in their entirety. In certain non-limiting embodiments, the barcode sequences range from about 4 nucleotides to about 25 nucleotides. In a particular embodiment, the barcode sequences range from about 4 nucleotides to about 7 nucleotides.

A barcode sequence can be attached to the template nucleic acid with an enzyme, or the entire nucleic acid can be synthesized. The enzyme may be a ligase or a polymerase. The ligase may be any enzyme capable of ligating an oligonucleotide (RNA or DNA) to the nucleic acid molecule. Suitable ligases include T4 DNA ligase and T4 RNA ligase (such ligases are available commercially, from New England Biolabs). Methods for using ligases are well known in the art. The polymerase may be any enzyme capable of adding nucleotides to the 3′ and the 5′ terminus of template nucleic acid molecules. Photo-ligation, chemical attachment, or other methods may also be used to attach the barcode sequence to the nucleic acid-based binder. Non-covalent attachment methods may also be used. One embodiment uses hybridization of complimentary oligonucleotides, between a nucleic acid covalently attached to the first binding agent and an oligonucleotide containing a target identifier.

The target identifier may be coupled to the first binding agent in a releasable manner, such that the identifier may be separated from the first binding agent for purposes of detection in certain embodiments. Alternatively, the target identifier is irreversibly coupled to the first binding agent and detection of the identifier occurs on the complex with the analyte, for example, in DNA sequencing.

In one embodiment for attachment, a modified oligonucleotide is incorporated to the end of an oligonucleotide-encoded identifier. The incorporation may include attaching a UV photo-cleavable primary amino group onto the 5′ end of the oligonucleotide binding agent, and subsequently directly attaching the identifier to a protein based binding agent via the amino group. In another embodiment, a UV photo-cleavable oligonucleotide is incorporated into a nucleic acid based binding agent.

Further attachment strategies involve using a bi-functional cross-linking reagent to directly attach an amino acid containing binding agent to an oligonucleotide-based identifier. Embodiments of the method include indirect method attachments, including but not limited to, hybridizing, or annealing, an oligonucleotide identifier to a complimentary oligonucleotide that is either linked to a protein-based binding agent, or incorporated in the sequence of a nucleic acid-based binding agents. Other formats or combinations of the above may also be included, such as attaching a biotinylated or desthiotinylated barcoded oligonucleotide bound to a streptavidin-modified binding agent; attaching DIG, dye, or biotinylated identifying oligonucleotide bound to an antibody to the same motifs bound to the binding agent; and other dimerization motifs, including protein-based nucleic acid-based, or chemical based. Other attachment strategies may be used for protein, nucleic acid, or non-protein or non-nucleic acid binding agents (e.g. chemical modification of lipids, sugars, or synthetic small molecules).

### Droplet Formation

Methods of the invention involve forming droplets containing template DNA bound to beads. Droplets of the invention include beads with attached nucleic acid template, suspended in a heat stable water-in-oil emulsion. It is contemplated that a plurality of the droplets, or microreactors, include one template and one bead. There may be droplets that do not contain a bead-template complex. However, there should be few droplets that contain more than one copy of a template. The emulsion may be formed according to any suitable method known in the art. One method of creating emulsion is described below but any method for making an emulsion may be used. These methods are known in the art and include adjuvant methods, counter-flow methods, cross-current methods, rotating drum methods, and membrane methods. Furthermore, the size of the microcapsules may be adjusted by varying the flow rate and speed of the components. For example, in dropwise addition, the size of the drops and the total time of delivery may be varied. Preferably, the emulsion contains a density of about 3,000 beads encapsulated per microliter.

Various emulsions that are suitable for biologic reactions are referred to in Griffiths and Tawfik, EMBO, 22, pp. 24-35 (2003); Ghadessy et al., Proc. Natl. Acad. Sci. USA 98, pp. 4552-4557 (2001); U.S. Pat. No. 6,489,103 and WO 02/22869, each fully incorporated herein by reference. It is noted that Griffiths et al., (U.S. Pat. No. 6,489,103 and WO 99/02671) refers to a method for in vitro sorting of one or more genetic elements encoding a gene products having a desired activity, i.e., compartmentalizing a gene, expressing the gene, and sorting the compartmentalized gene based on the expressed product.

The emulsion is preferably generated by adding beads to an amplification solution. As used herein, the term “amplification solution” means the sufficient mixture of reagents that is necessary to perform amplification of template DNA. One example of an amplification solution, a PCR amplification solution, is provided in the Examples below. It will be appreciated that various modifications may be made to the amplification solution based on the type of amplification being performed and whether the template DNA is attached to the beads or provided in solution. In one embodiment, the mixture of beads and amplification solution is added dropwise into a spinning mixture of biocompatible oil (e.g., light mineral oil, Sigma) and allowed to emulsify. In another embodiment, the beads and amplification solution are added dropwise into a cross-flow of biocompatible oil. The oil used may be supplemented with one or more biocompatible emulsion stabilizers. These emulsion stabilizers may include Atlox 4912, Span 80, and other recognized and commercially available suitable stabilizers. In preferred aspects, the emulsion is heat stable to allow thermal cycling, e.g., to at least 94° C., at least 95° C., or at least 96° C. Preferably, the droplets formed range in size from about 5 microns to about 500 microns, more preferably from about 10 microns to about 350 microns, even more preferably from about 50 to 250 microns, and most preferably from about 100 microns to about 200 microns. Advantageously, cross-flow fluid mixing allows for control of the droplet formation, and uniformity of droplet size. We note that smaller water droplets not containing beads may be present in the emulsion.

The microreactors (i.e., droplets) should be sufficiently large to encompass sufficient amplification reagents for the degree of amplification required. However, the microreactors should be sufficiently small so that a population of microreactors, each containing a member of a DNA library, can be amplified by conventional laboratory equipment, e.g., PCR thermocycling equipment, test tubes, incubators and the like. Notably, the use of microreactors allows amplification of complex mixtures of templates (e.g., genomic DNA samples or whole cell RNA) without intermixing of sequences, or domination by one or more templates (e.g., PCR selection bias; see, Wagner et al., 1994, Suzuki and Giovannoni, 1996; Chandler et al., 1997, Polz and Cavanaugh, 1998).

With the limitations described above, the optimal size of a microreactor may be on average 100 to 200 microns in diameter. Microreactors of this size would allow amplification of a DNA library comprising about 600,000 members in a suspension of microreactors of less than 10 ml in volume. For example, if PCR is the chosen amplification method, 10 ml of microreactors would fit into 96 tubes of a regular thermocycler with 96 tube capacity. In a preferred embodiment, the suspension of 600,000 microreactors would have a volume of less than 1 ml. A suspension of less than 1 ml may be amplified in about 10 tubes of a conventional PCR thermocycler. In a most preferred embodiment, the suspension of 600,000 microreactors would have a volume of less than 0.5 ml.

Another embodiment of the invention is directed to a method of performing nucleic acid amplification with a template and a bead, but without attachment of the template to the bead. In one aspect, the bead may comprise a linker molecule that can bind the amplified nucleic acid after amplification. For example, the linker may be a linker that can be activated. Such linkers are well known and include temperature sensitive or salt sensitive binding pairs such as streptavidin/biotin and antibodies/antigen. The template nucleic acid may be encapsulated with a bead and amplified. Following amplification, the amplified nucleic acid may be linked to the beads, e.g., by adjustments in temperature or salt concentration.

### Amplification in Droplets

In order for the template DNA (i.e., the amplicons generated by the primary amplification method) to be sequenced according to the methods of this invention the copy number must be amplified a second time to generate a sufficient number of copies, or amplicons, of each template to produce a detectable signal, for example, by a light detection means. Any suitable nucleic acid amplification means may be used. In a preferred embodiment, emulsion PCR amplification (i.e., amplification in droplets, also known in the art as Emulsion Based Clonal Amplification (EBCA) or bead emulsion amplification) is used to perform this second amplification. These methods are also discussed in U.S. Pub. No. 2006/0228721, published Oct. 12, 2006, the contents of which is hereby incorporated by reference in its entirety.

Emulsion PCR is performed by attaching a template nucleic acid (e.g., DNA) to be amplified to a solid support, preferably in the form of a generally spherical bead. A library of single stranded template DNA prepared according to the sample preparation methods of this invention is an example of one suitable source of the starting nucleic acid template library to be attached to a bead for use in this amplification method. In a preferred embodiment, this template DNA is denatured prior to droplet formation and amplification.

The bead is linked to a large number of a single primer species that is complementary to a region of the template DNA. Template DNA annealed to the bead bound primer.

The specific number of template DNA molecules per bead was determined after testing multiple inputs, ranging from 2 DNA molecules per bead to 0.5 DNA molecules per bead. Two criteria were used to judge the best ratio of DNA molecules to capture beads. The first is the yield of beads after enrichment, and the second is the number of passed sequencing reads along with the % Dot+Mixed reads. The % Dot+Mixed reads represents sequencing reads with more than one template per emPCR capture bead. The yield of enriched beads must be within a small window of the GS Junior Bead Counter. In experiments, greater than 1 DNA molecule per bead generated enriched beads above the window in the bead counter (>20% enrichment), which indicates that many of the templates are mixed. At the other end of the range, 0.5 DNA molecules per capture bead generated enriched beads at the lower limit of the window, which may not consistently generate sufficient beads for a sequencing run (500K beads/run). Therefore, the invention provides a final concentration of 1 DNA molecule per bead.

The beads are suspended in aqueous reaction mixture and then encapsulated in a water-in-oil emulsion. The emulsion is composed of discrete aqueous phase microdroplets, approximately 60 to 200 μm in diameter, enclosed by a thermostable oil phase. Each microdroplet contains, preferably, amplification reaction solution (i.e., the reagents necessary for nucleic acid amplification). An example of an amplification would be a PCR reaction mix (polymerase, salts, dNTPs) and a pair of PCR primers (primer A and primer B). A subset of the microdroplet population also contains the DNA bead comprising the DNA template. This subset of microdroplet is the basis for the amplification. Some droplets that are not within this subset have no template DNA and will not participate in amplification. In one embodiment, the amplification technique is PCR and the PCR primers are present in a 8:1 or 16:1 ratio (i.e., 8 or 16 of one primer to 1 of the second primer) to perform asymmetric PCR.

In this overview, the DNA is annealed to an oligonucleotide (primer B) which is immobilized to a bead. During thermocycling the bond between the single stranded DNA template and the immobilized B primer on the bead is broken, releasing the template into the surrounding microencapsulated solution. The amplification solution, in this case, the PCR solution, contains addition solution phase primer A and primer B. Solution phase B primers readily bind to the complementary b′ region of the template as binding kinetics are more rapid for solution phase primers than for immobilized primers. In early phase PCR, both A and B strands amplify equally well.

By midphase PCR (i.e., between cycles 10 and 30) the B primers are depleted, halting exponential amplification. The reaction then enters asymmetric amplification and the amplicon population becomes dominated by A strands. In late phase PCR, after 30 to 40 cycles, asymmetric amplification increases the concentration of A strands in solution. Excess A strands begin to anneal to bead immobilized B primers. Thermostable polymerases then utilize the A strand as a template to synthesize an immobilized, bead bound B strand of the amplicon.

In final phase PCR, continued thermal cycling forces additional annealing to bead bound primers. Solution phase amplification may be minimal at this stage but concentration of immobilized B strands increase. Then, the emulsion is broken and the immobilized product is rendered single stranded by denaturing (by heat, pH etc.) which removes the complimentary A strand. The A primers are annealed to the A′ region of immobilized strand, and immobilized strand is loaded with sequencing enzymes, and any necessary accessory proteins. The beads are then sequenced using recognized pyrophosphate techniques (described, e.g., in U.S. Pat. Nos. 6,274,320, 6,258,568 and 6,210,891, incorporated in toto herein by reference).

In a preferred embodiment, the primers used for amplification are bipartite—comprising a 5′ section and a 3′ section. The 3′ section of the primer contains target specific sequence and performed the function of PCR primers. The 5′ section of the primer comprises sequences which are useful for the sequencing method or the immobilization method. For example, the 5′ section of the two primers used for amplification can contain sequences (e.g., labeled 454 forward and 454 reverse) which are complementary to primers on a bead or a sequencing primer. That is, the 5′ section, containing the forward or reverse sequence, allows the amplicons to attach to beads that contain immobilized oligos which are complementary to the forward or reverse sequence. Furthermore, sequencing reaction may be initiated using sequencing primers which are complementary to the forward and reverse primer sequences. Thus one set of beads comprising sequences complementary to the 5′ section of the bipartite primer may be used on all reactions. Similarly, one set of sequencing primers comprising sequences complementary to the 5′ section of the bipartite primer may be used to sequence any amplicons made using the bipartite primer. In the most preferred embodiment, all bipartite primer sets used for amplification would have the same set of 5′ sections such as the 454 forward primer and 454 reverse primer. In this case, all amplicons may be analyzed using standard beads coated with oligos complementary to the 5′ section. The same oligos (immobilized on beads or not immobilized) may be used as sequencing oligos.

### Droplet Breaking and Bead Recovery

Following amplification of the template, the droplets are “broken” (also referred to as “demulsification” in the art). There are many methods of breaking an emulsion (see, e.g., U.S. Pat. No. 5,989,892 and references cited therein) and one of skill in the art would be able to select the proper method.

After the emulsion is broken, the amplified template-containing beads may then be resuspended in aqueous solution for use, for example, in a sequencing reaction according to known technologies. (See, Sanger, F. et al., Proc. Natl. Acad. Sci. U.S.A. 75, 5463-5467 (1977); Maxam, A. M. & Gilbert, W. Proc Natl Acad Sci USA 74, 560-564 (1977); Ronaghi, M. et al., Science 281, 363, 365 (1998); Lysov, I. et al., Dokl Akad Nauk SSSR 303, 1508-1511 (1988); Bains W. & Smith G. C. J. TheorBiol 135, 303-307 (1988); Drnanac, R. et al., Genomics 4, 114-128 (1989); Khrapko, K. R. et al., FEBS Lett 256. 118-122 (1989); Pevzner P. A. J Biomol Struct Dyn 7, 63-73 (1989); Southern, E. M. et al., Genomics 13, 1008-1017 (1992).) If the beads are to be used in a pyrophosphate-based sequencing reaction (described, e.g., in U.S. Pat. Nos. 6,274,320, 6,258,568 and 6,210,891, and incorporated in toto herein by reference), then it is necessary to remove the second strand of the PCR product and anneal a sequencing primer to the single stranded template that is bound to the bead.

At this point, the amplified DNA on the bead may be sequenced either directly on the bead or in a different reaction vessel. In an embodiment of the present invention, the DNA is sequenced directly on the bead by transferring the bead to a reaction vessel and subjecting the DNA to a sequencing reaction (e.g., pyrophosphate or Sanger sequencing). Alternatively, the beads may be isolated and the DNA may be removed from each bead and sequenced. In either case, the sequencing steps may be performed on each individual bead.

### Sequencing

Sequencing may be by any method known in the art. DNA sequencing techniques include classic dideoxy sequencing reactions (Sanger method) using labeled terminators or primers and gel separation in slab or capillary, sequencing by synthesis using reversibly terminated labeled nucleotides, pyrosequencing, 454 sequencing, allele specific hybridization to a library of labeled oligonucleotide probes, sequencing by synthesis using allele specific hybridization to a library of labeled clones that is followed by ligation, real time monitoring of the incorporation of labeled nucleotides during a polymerization step, polony sequencing, and SOLiD sequencing. Sequencing of separated molecules has more recently been demonstrated by sequential or single extension reactions using polymerases or ligases as well as by single or sequential differential hybridizations with libraries of probes.

One method of sequencing is pyrophosphate-based sequencing. In pyrophosphate based sequencing sample DNA sequence and the extension primer subjected to a polymerase reaction in the presence of a nucleotide triphosphate whereby the nucleotide triphosphate will only become incorporated and release pyrophosphate (PPi) if it is complementary to the base in the target position, the nucleotide triphosphate being added either to separate aliquots of sample-primer mixture or successively to the same sample-primer mixture. The release of PPi is then detected to indicate which nucleotide is incorporated.

In an embodiment, a region of the sequence product is determined by annealing a sequencing primer to a region of the template nucleic acid, and then contacting the sequencing primer with a DNA polymerase and a known nucleotide triphosphate, i.e., dATP, dCTP, dGTP, dTTP, or an analog of one of these nucleotides. The sequence can be determined by detecting a sequence reaction byproduct, as is described below.

The sequence primer can be any length or base composition, as long as it is capable of specifically annealing to a region of the amplified nucleic acid template. No particular structure for the sequencing primer is required so long as it is able to specifically prime a region on the amplified template nucleic acid. Preferably, the sequencing primer is complementary to a region of the template that is between the sequence to be characterized and the sequence hybridizable to the anchor primer. The sequencing primer is extended with the DNA polymerase to form a sequence product. The extension is performed in the presence of one or more types of nucleotide triphosphates, and if desired, auxiliary binding proteins.

Incorporation of the dNTP is preferably determined by assaying for the presence of a sequencing byproduct. In a preferred embodiment, the nucleotide sequence of the sequencing product is determined by measuring inorganic pyrophosphate (PPi) liberated from a nucleotide triphosphate (dNTP) as the dNMP is incorporated into an extended sequence primer. This method of sequencing, termed Pyrosequencing™ technology (PyroSequencing AB, Stockholm, Sweden) can be performed in solution (liquid phase) or as a solid phase technique. PPi-based sequencing methods are described generally in, e.g., WO9813523A1, Ronaghi, et al., 1996. Anal. Biochem. 242: 84-89, Ronaghi, et al., 1998. Science 281: 363-365 (1998) and USSN 2001/0024790. These disclosures of PPi sequencing are incorporated herein in their entirety, by reference. See also, e.g., U.S. Pat. Nos. 6,210,891 and 6,258,568, each fully incorporated herein by reference.

In a preferred embodiment, DNA sequencing is performed using 454 corporation's (454 Life Sciences) sequencing apparatus and methods (Margulies, M et al. 2005, Nature, 437, 376-380), which are disclosed in patent applications U.S. Ser. No. 10/768,729, U.S. Ser. No. 10/767,779, U.S. Ser. No. 10/767,899, and U.S. Ser. No. 10/767,894—all of which are filed Jan. 28, 2004, and are herein incorporated by reference in their entireties. In certain embodiments, a Roche 454 GS Jr sequencer is used.

In some embodiments, 454 sequencing involves two steps. In the first step, DNA is sheared into fragments of approximately 300-800 base pairs, and the fragments are blunt ended. Oligonucleotide adaptors are then ligated to the ends of the fragments. The adaptors serve as primers for amplification and sequencing of the fragments. The fragments can be attached to DNA capture beads, e.g., streptavidin-coated beads using, e.g., Adaptor B, which contains 5′-biotin tag. The fragments attached to the beads are PCR amplified within droplets of an oil-water emulsion, as discussed above. The result is multiple copies of clonally amplified DNA fragments on each bead. In the second step, the beads are captured in wells (pico-liter sized). Pyrosequencing is performed on each DNA fragment in parallel. Addition of one or more nucleotides generates a light signal that is recorded by a CCD camera in a sequencing instrument. The signal strength is proportional to the number of nucleotides incorporated. Pyrosequencing makes use of pyrophosphate (PPi) which is released upon nucleotide addition. PPi is converted to ATP by ATP sulfurylase in the presence of adenosine 5′ phosphosulfate. Luciferase uses ATP to convert luciferin to oxyluciferin, and this reaction generates light that is detected and analyzed.

Another sequencing technique that can be used in the methods of the provided invention includes, for example, Helicos True Single Molecule Sequencing (tSMS) (Harris T. D. et al. (2008) Science 320:106-109). In the tSMS technique, a DNA sample is cleaved into strands of approximately 100 to 200 nucleotides, and a polyA sequence is added to the 3′ end of each DNA strand. Each strand is labeled by the addition of a fluorescently labeled adenosine nucleotide. The DNA strands are then hybridized to a flow cell, which contains millions of oligo-T capture sites that are immobilized to the flow cell surface. The templates can be at a density of about 100 million templates/cm². The flow cell is then loaded into an instrument, e.g., HeliScope™ sequencer, and a laser illuminates the surface of the flow cell, revealing the position of each template. A CCD camera can map the position of the templates on the flow cell surface. The template fluorescent label is then cleaved and washed away. The sequencing reaction begins by introducing a DNA polymerase and a fluorescently labeled nucleotide. The oligo-T nucleic acid serves as a primer. The polymerase incorporates the labeled nucleotides to the primer in a template directed manner. The polymerase and unincorporated nucleotides are removed. The templates that have directed incorporation of the fluorescently labeled nucleotide are detected by imaging the flow cell surface. After imaging, a cleavage step removes the fluorescent label, and the process is repeated with other fluorescently labeled nucleotides until the desired read length is achieved. Sequence information is collected with each nucleotide addition step. Further description of tSMS is shown for example in Lapidus et al. (U.S. Pat. No. 7,169,560), Lapidus et al. (U.S. patent application number 2009/0191565), Quake et al. (U.S. Pat. No. 6,818,395), Harris (U.S. Pat. No. 7,282,337), Quake et al. (U.S. patent application number 2002/0164629), and Braslaysky, et al., PNAS (USA), 100: 3960-3964 (2003), the contents of each of these references is incorporated by reference herein in its entirety.

Another example of a DNA sequencing technique that can be used in the methods of the provided invention is SOLiD technology (Applied Biosystems). In SOLiD sequencing, genomic DNA is sheared into fragments, and adaptors are attached to the 5′ and 3′ ends of the fragments to generate a fragment library. Alternatively, internal adaptors can be introduced by ligating adaptors to the 5′ and 3′ ends of the fragments, circularizing the fragments, digesting the circularized fragment to generate an internal adaptor, and attaching adaptors to the 5′ and 3′ ends of the resulting fragments to generate a mate-paired library. Next, clonal bead populations are prepared in microreactors containing beads, primers, template, and PCR components. Following PCR, the templates are denatured and beads are enriched to separate the beads with extended templates. Templates on the selected beads are subjected to a 3′ modification that permits bonding to a glass slide. The sequence can be determined by sequential hybridization and ligation of partially random oligonucleotides with a central determined base (or pair of bases) that is identified by a specific fluorophore. After a color is recorded, the ligated oligonucleotide is cleaved and removed and the process is then repeated.

Another example of a DNA sequencing technique that can be used in the methods of the provided invention is Ion Torrent sequencing (U.S. patent application numbers 2009/0026082, 2009/0127589, 2010/0035252, 2010/0137143, 2010/0188073, 2010/0197507, 2010/0282617, 2010/0300559), 2010/0300895, 2010/0301398, and 2010/0304982), the content of each of which is incorporated by reference herein in its entirety. In Ion Torrent sequencing, DNA is sheared into fragments of approximately 300-800 base pairs, and the fragments are blunt ended. Oligonucleotide adaptors are then ligated to the ends of the fragments. The adaptors serve as primers for amplification and sequencing of the fragments. The fragments can be attached to a surface and are attached at a resolution such that the fragments are individually resolvable. Addition of one or more nucleotides releases a proton (H⁺), which signal detected and recorded in a sequencing instrument. The signal strength is proportional to the number of nucleotides incorporated.

Another example of a sequencing technology that can be used in the methods of the provided invention is Illumina sequencing. Illumina sequencing is based on the amplification of DNA on a solid surface using fold-back PCR and anchored primers. Genomic DNA is fragmented, and adapters are added to the 5′ and 3′ ends of the fragments. DNA fragments that are attached to the surface of flow cell channels are extended and bridge amplified. The fragments become double stranded, and the double stranded molecules are denatured. Multiple cycles of the solid-phase amplification followed by denaturation can create several million clusters of approximately 1,000 copies of single-stranded DNA molecules of the same template in each channel of the flow cell. Primers, DNA polymerase and four fluorophore-labeled, reversibly terminating nucleotides are used to perform sequential sequencing. After nucleotide incorporation, a laser is used to excite the fluorophores, and an image is captured and the identity of the first base is recorded. The 3′ terminators and fluorophores from each incorporated base are removed and the incorporation, detection and identification steps are repeated.

Another example of a sequencing technology that can be used in the methods of the provided invention includes the single molecule, real-time (SMRT) technology of Pacific Biosciences. In SMRT, each of the four DNA bases is attached to one of four different fluorescent dyes. These dyes are phospholinked. A single DNA polymerase is immobilized with a single molecule of template single stranded DNA at the bottom of a zero-mode waveguide (ZMW). A ZMW is a confinement structure which enables observation of incorporation of a single nucleotide by DNA polymerase against the background of fluorescent nucleotides that rapidly diffuse in an out of the ZMW (in microseconds). It takes several milliseconds to incorporate a nucleotide into a growing strand. During this time, the fluorescent label is excited and produces a fluorescent signal, and the fluorescent tag is cleaved off. Detection of the corresponding fluorescence of the dye indicates which base was incorporated. The process is repeated.

Another example of a sequencing technique that can be used in the methods of the provided invention is nanopore sequencing (Soni G V and Meller A. (2007) Clin Chem 53: 1996-2001). A nanopore is a small hole, of the order of 1 nanometer in diameter. Immersion of a nanopore in a conducting fluid and application of a potential across it results in a slight electrical current due to conduction of ions through the nanopore. The amount of current which flows is sensitive to the size of the nanopore. As a DNA molecule passes through a nanopore, each nucleotide on the DNA molecule obstructs the nanopore to a different degree. Thus, the change in the current passing through the nanopore as the DNA molecule passes through the nanopore represents a reading of the DNA sequence.

Another example of a sequencing technique that can be used in the methods of the provided invention involves using a chemical-sensitive field effect transistor (chemFET) array to sequence DNA (for example, as described in US Patent Application Publication No. 20090026082). In one example of the technique, DNA molecules can be placed into reaction chambers, and the template molecules can be hybridized to a sequencing primer bound to a polymerase. Incorporation of one or more triphosphates into a new nucleic acid strand at the 3′ end of the sequencing primer can be detected by a change in current by a chemFET. An array can have multiple chemFET sensors. In another example, single nucleic acids can be attached to beads, and the nucleic acids can be amplified on the bead, and the individual beads can be transferred to individual reaction chambers on a chemFET array, with each chamber having a chemFET sensor, and the nucleic acids can be sequenced.

Another example of a sequencing technique that can be used in the methods of the provided invention involves using a electron microscope (Moudrianakis E. N. and Beer M. Proc Natl Acad Sci USA. 1965 March; 53:564-71). In one example of the technique, individual DNA molecules are labeled using metallic labels that are distinguishable using an electron microscope. These molecules are then stretched on a flat surface and imaged using an electron microscope to measure sequences.

Additional detection methods can utilize binding to microarrays for subsequent fluorescent or non-fluorescent detection, barcode mass detection using a mass spectrometric methods, detection of emitted radiowaves, detection of scattered light from aligned barcodes, fluorescence detection using quantitative PCR or digital PCR methods.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are therefore intended to be embraced therein.

### EXAMPLES

### Example 1

### emPCR Amplification

1.a. Preparation of DNA Capture Beads

Packed beads from a 1 mL N-hydroxysuccinimide ester (NHS)-activated Sepharose HP affinity column (Amersham Biosciences, Piscataway, N.J.) are removed from the column and activated as described in the product literature (Amersham Pharmacia Protocol #71700600AP). Twenty-five microliters of a 1 mM amine-labeled HEG capture primer (5′-Amine-3 sequential 18-atom hexa-ethyleneglycol spacers CCATCTGTTGCGTGCGTGTC-3′ SEQ ID NO: 1) (IDT Technologies, Coralville, Iowa, USA) in 20 mM phosphate buffer, pH 8.0, is bound to the beads, after which 25-36 μm beads are selected by serial passage through 36 and 25 μm pore filter mesh sections (Sefar America, Depew, N.Y., USA).

DNA capture beads that pass through the first filter, but are retained by the second are collected in bead storage buffer (50 mM Tris, 0.02% Tween, 0.02% sodium azide, pH 8), quantitated with a Multisizer 3 Coulter Counter (Beckman Coulter, Fullerton, Calif., USA) and stored at 4° C. until needed.

1.b. Binding Template Species to DNA Capture Beads

Template molecules are denatured at 94 degrees for 3 minutes prior to annealing them to primers.

Template molecules are annealed to complementary primers on the DNA Capture beads in a UV-treated laminar flow hood. The desired number of DNA capture beads suspended in bead storage buffer are transferred to a 200 μL PCR tube, centrifuged in a benchtop mini centrifuge for 10 seconds, the tube rotated 180° and spun for an additional 10 seconds to ensure even pellet formation. In certain embodiments, the desired number is 600,000. In certain embodiments, the desired number is the same number as the number of template DNA molecules that are added to the beads.

In certain embodiments, the number of beads and the number of template DNA molecules are within approximately 10%, 5%, 2%, 1%, 0.5%, 0.01%, 0.005%, 0.001%, 0.0005%, or 0.0001% of each other. In certain embodiments, the number of beads and the number of template DNA molecules are within precisely 10%, 5%, 2%, 1%, 0.5%, 0.01%, 0.005%, 0.001%, 0.0005%, or 0.0001% of each other. In certain embodiments, the number of beads and the number of template DNA molecules are approximately the same. In certain embodiments, the number of beads and the number of template DNA molecules are precisely the same.

The supernatant is then removed, and the beads washed with 200 μL of Annealing Buffer (20 mM Tris, pH 7.5 and 5 mM magnesium acetate), vortexed for 5 seconds to resuspend the beads, and pelleted as above. All but approximately 10 μL of the supernatant above the beads are removed, and an additional 200 μL of Annealing Buffer is added. The beads are vortexed again for 5 seconds, allowed to sit for 1 minute, then pelleted as above. All but 10 μL of supernatant are discarded, and molecules of template library are added to the beads. In certain embodiments, a number molecules per μL template library are added to the beads, the number being chosen to yield an average of 1 template molecule per bead. In certain embodiments, this number is chosen to yield precisely 1 template molecule per bead. In certain embodiments, this number is chosen to yield 1 template molecule bound to each bead after binding, either precisely or approximately. In certain embodiments, this number is chosen so that fewer than 2% of the beads have more than 1 template molecule bound to them. In certain embodiments, this number is chosen so that fewer than 2% of the beads end up having more than 1 different template molecule bound to them. In a preferred embodiment, a number of beads and a number of template molecules is chosen so that each bead has one template molecule attached to it. In certain embodiments, 0.48 μL of 2×10⁷ molecules per μL template library are added to the beads

The tube is vortexed for 5 seconds to mix the contents, after which the templates are annealed to the beads in a controlled denaturation/annealing program preformed in an MJ thermocycler (5 minutes at 80° C., followed by a decrease by 0.1° C./sec to 70° C., 1 minute at 70° C., decrease by 0.1° C./sec to 60° C., hold at 60° C. for 1 minute, decrease by 0.1° C./sec to 50° C., hold at 50° C. for 1 minute, decrease by 0.1° C./sec to 20° C., hold at 20° C.). Upon completion of the annealing process the beads can be stored on ice until needed.

1.c. PCR Reaction Mix Preparation and Formulation

To reduce the possibility of contamination, the PCR reaction mix is prepared in a in a UV-treated laminar flow hood located in a PCR clean room. For each 600,000 bead emulsion PCR reaction, 225 μL of reaction mix (1× Platinum HiFi Buffer (Invitrogen), 1 mM dNTPs (Pierce), 2.5 mM MgSO.sub.4 (Invitrogen), 0.1% Acetylated, molecular biology grade BSA (Sigma), 0.01% Tween-80 (Acros Organics), 0.003 U/μL thermostable pyrophosphatase, 0.313 μM forward (5′-CGTTTCCCCTGTGTGCCTTG-3′ SEQ ID NO: 2), and 0.020 μM reverse primers (5′-CCATCTGTTGCGTGCGTGTC-3′ SEQ ID NO: 1) (IDT Technologies, Coralville, Iowa, USA), and 0.15 U/μL Platinum Hi-Fi Taq Polymerase (Invitrogen) are prepared in a 1.5 mL tube. Twenty-five microliters of the reaction mix are removed and stored in an individual 200 μL PCR tube for use as a negative control. Both the reaction mix and negative controls are stored on ice until needed. Additionally, 240 μL of mock amplification mix (1× Platinum HiFi Buffer (Invitrogen), 2.5 mM MgSO.sub.4 (Invitrogen), 0.1% BSA, 0.01% Tween) for every emulsion are prepared in a 1.5 mL tube, and similarly stored at room temperature until needed.

1.d. Emulsification and Amplification

The emulsification process creates a heat-stable water-in-oil emulsion with approximately 10,000 discrete PCR microreactors (i.e., droplets with a bead and a DNA template) per microliter which serve as a matrix for single molecule, clonal amplification of the individual molecules of the target library. The reaction mixture and DNA capture beads for a single reaction are emulsified in the following manner: in a UV-treated laminar flow hood, 200 μL of PCR solution are added to the tube containing the 600,000 DNA capture beads. The beads are resuspended through repeated pipette action, after which the PCR-bead mixture is permitted to sit at room temperature for at least 2 minutes, allowing the beads to equilibrate with the PCR solution. Meanwhile, 400 μL of Emulsion Oil (60% (w/w) DC 5225C Formulation Aid (Dow Chemical CO, Midland, Mich.), 30% (w/w) DC 749 Fluid (Dow Chemical CO, Midland, Mich.), and 30% (w/w) Ar20 Silicone Oil (Sigma)) are aliquotted into a flat-topped 2 mL centrifuge tube (Dot Scientific). The 240 μL of mock amplification mix are then added to 400 μL of emulsion oil, the tube capped securely and placed in a 24 well TissueLyser Adaptor (Qiagen) of a TissueLyser MM300 (Retsch GmbH & Co. KG, Haan, Germany). The emulsion is homogenized for 5 minutes at 25 oscillations/sec to generate the extremely small emulsions, or “microfines”, that confer additional stability to the reaction.

During the microfine formation, 160 μL of the PCR amplification mix are added to the mixture of annealed templates and DNA capture beads. The combined beads and PCR reaction mix are briefly vortexed and allowed to equilibrate for 2 minutes. After the microfines had been formed, the amplification mix, templates and DNA capture beads are added to the emulsified material. The TissueLyser speed is reduced to 15 oscillations per second and the reaction mix homogenized for 5 minutes. The lower homogenization speed created water droplets in the oil mix with an average diameter of 100 to 150 μm, sufficiently large to contain DNA capture beads and amplification mix.

The emulsion is aliquotted into 7 to 8 separate PCR tubes each containing roughly 80 μL. The tubes are sealed and placed in a MJ thermocycler along with the 25 μl negative control made previously. The following cycle times are used: 1× (4 minutes at 94° C.)—Hotstart Initiation, 40× (30 seconds at 94° C., 60 seconds at 58° C., 90 seconds at 68° C.)—Amplification, 13× (30 seconds at 94° C., 360 seconds at 58° C.)—Hybridization Extension. After completion of the PCR program, the reactions are removed and the emulsions either broken immediately (as described below) or the reactions stored at 110° C. for up to 16 hours prior to initiating the breaking process.

1.e. Breaking the Emulsion and Recovery of Beads

Fifty microliters of isopropyl alcohol (Fisher) are added to each PCR tube containing the emulsion of amplified material, and vortexed for 10 seconds to lower the viscosity of the emulsion. The tubes are centrifuged for several seconds in a microcentrifuge to remove any emulsified material trapped in the tube cap. The emulsion-isopropyl alcohol mix is withdrawn from each tube into a 10 mL BD-Disposable Syringe (Fisher Scientific) fitted with a blunt 16 gauge blunt needle (Brico Medical Supplies). An additional 50 μL of isopropyl alcohol are added to each PCR tube, vortexed, centrifuged as before, and added to the contents of the syringe. The volume inside the syringe is increased to 9 mL with isopropyl alcohol, after which the syringe is inverted and 1 mL of air is drawn into the syringe to facilitate mixing the isopropanol and emulsion. The blunt needle is removed, a 25 mm Swinlock filter holder (Whatman) containing 15 μm pore Nitex Sieving Fabric (Sefar America, Depew, N.Y., USA) attached to the syringe luer, and the blunt needle affixed to the opposite side of the Swinlock unit.

The contents of the syringe are gently but completely expelled through the Swinlock filter unit and needle into a waste container with bleach. Six milliliters of fresh isopropyl alcohol are drawn back into the syringe through the blunt needle and Swinlock filter unit, and the syringe is inverted a number of times to mix the isopropyl alcohol, beads and remaining emulsion components. In certain embodiments, the syringe is inverted ten times. In certain embodiments, the syringe is inverted eight times. The contents of the syringe are again expelled into a waste container, and the wash process repeated twice with 6 mL of additional isopropyl alcohol in each wash. The wash step is repeated with 6 mL of 80% Ethanol/1× Annealing Buffer (80% Ethanol, 20 mM Tris-HCl, pH 7.6, 5 mM Magnesium Acetate). The beads are then washed with 6 mL of 1× Annealing Buffer with 0.1% Tween (0.1% Tween-20, 20 mM Tris-HCl, pH 7.6, 5 mM Magnesium Acetate), followed by a 6 mL wash with picopure water.

After expelling the final wash into the waste container, 1.5 mL of 1 mM EDTA are drawn into the syringe, and the Swinlock filter unit removed and set aside. The contents of the syringe are serially transferred into a 1.5 mL centrifuge tube. The tube is periodically centrifuged for 20 seconds in a minifuge to pellet the beads and the supernatant removed, after which the remaining contents of the syringe are added to the centrifuge tube. The Swinlock unit is reattached to the filter and 1.5 mL of EDTA drawn into the syringe. The Swinlock filter is removed for the final time, and the beads and EDTA added to the centrifuge tube, pelletting the beads and removing the supernatant as necessary.

1.f. Second-Strand Removal

Amplified DNA, immobilized on the capture beads, is rendered single stranded by removal of the secondary strand through incubation in a basic melt solution. One mL of freshly prepared Melting Solution (0.125 M NaOH, 0.2 M NaCl) is added to the beads, the pellet resuspended by vortexing at a medium setting for 2 seconds, and the tube placed in a Thermolyne LabQuake tube roller for 3 minutes. The beads are then pelleted as above, and the supernatant carefully removed and discarded. The residual melt solution was then diluted by the addition of 1 mL Annealing Buffer (20 mM Tris-Acetate, pH 7.6, 5 mM Magnesium Acetate), after which the beads are vortexed at medium speed for 2 seconds, and the beads pelleted, and supernatant removed as before. The Annealing Buffer wash is repeated, except that only 800 μL of the Annealing Buffer are removed after centrifugation. The beads and remaining Annealing Buffer are transferred to a 0.2 mL PCR tube, and either used immediately or stored at 4° C. for up to 48 hours before continuing with the subsequent enrichment process.

1.g. Enrichment of Beads

Up to this point the bead mass is comprised of both beads with amplified, immobilized DNA strands, and null beads with no amplified product. The enrichment process is utilized to selectively capture beads with sequenceable amounts of template DNA while rejecting the null beads.

The single stranded beads from the previous step are pelleted by 10 second centrifugation in a benchtop mini centrifuge, after which the tube is rotated 180° and spun for an additional 10 seconds to ensure even pellet formation. As much supernatant as possible is then removed without disturbing the beads. Fifteen microliters of Annealing Buffer are added to the beads, followed by 2 μL of 100 μM biotinylated, 40 base HEG enrichment primer (5′ Biotin-18-atom hexa-ethyleneglycol spacer—CGTTTCCCCTGTGTGCCTTGCCATCTGTTCCCTCCCTGTC-3′ SEQ ID NO: 3, IDT Technologies, complementary to the combined amplification and sequencing sites (each 20 bases in length) on the 3′-end of the bead-immobilized template. The solution is mixed by vortexing at a medium setting for 2 seconds, and the enrichment primers annealed to the immobilized DNA strands using a controlled denaturation/annealing program in an MJ thermocycler (30 seconds at 65° C., decrease by 0.1° C./sec to 58° C., 90 seconds at 58° C., and a 10° C. hold).

While the primers are annealing, a stock solution of SeraMag-30 magnetic streptavidin beads (Seradyn, Indianapolis, Ind., USA) is resuspended by gentle swirling, and 20 μL of SeraMag beads are added to a 1.5 mL microcentrifuge tube containing 1 mL of Enhancing Fluid (2 M NaCl, 10 mM Tris-HCl, 1 mM EDTA, pH 7.5). The SeraMag bead mix is vortexed for 5 seconds, and the tube placed in a Dynal MPC—S magnet, pelletting the paramagnetic beads against the side of the microcentrifuge tube. The supernatant is carefully removed and discarded without disturbing the SeraMag beads, the tube removed from the magnet, and 100 μL of enhancing fluid were added. The tube is vortexed for 3 seconds to resuspend the beads, and the tube stored on ice until needed.

Upon completion of the annealing program, 100 μL of Annealing Buffer are added to the PCR tube containing the DNA Capture beads and enrichment primer, the tube vortexed for 5 seconds, and the contents transferred to a fresh 1.5 mL microcentrifuge tube. The PCR tube in which the enrichment primer is annealed to the capture beads is washed once with 200 μL of annealing buffer, and the wash solution added to the 1.5 mL tube. The beads are washed three times with 1 mL of annealing buffer, vortexed for 2 seconds, pelleted as before, and the supernatant carefully removed. After the third wash, the beads are washed twice with 1 mL of ice cold enhancing fluid, vortexed, pelleted, and the supernatant removed as before. The beads are then resuspended in 150 μL ice cold enhancing fluid and the bead solution added to the washed SeraMag beads.

The bead mixture is vortexed for 3 seconds and incubated at room temperature for 3 minutes on a LabQuake tube roller, while the streptavidin-coated SeraMag beads bound to the biotinylated enrichment primers anneal to immobilized templates on the DNA capture beads. The beads are then centrifuged at 2,000 RPM for 3 minutes; after which the beads are gently flicked or inverted until the beads were resuspended. In certain embodiments, the beads are resuspended by inversions of the mixture. In certain embodiments, the mixture is inverted 8 times. The resuspended beads are then placed on ice. In certain embodiments, resuspended beads are placed on ice for 5 minutes. In certain embodiments, the resuspended beads are placed on ice for 3 minutes.

Following the incubation on ice, cold Enhancing Fluid is added to the beads to a final volume of 1.5 mL. The tube inserted into a Dynal MPC—S magnet, and the beads are left undisturbed for 120 seconds to allow the beads to pellet against the magnet, after which the supernatant (containing excess SeraMag and null DNA capture beads) is carefully removed and discarded.

The tube is removed from the MPC-S magnet, 1 mL of cold enhancing fluid added to the beads, and the beads resuspended with gentle flicking or inversion of the tube. In a preferred embodiment, the beads are not vortexed, as vortexing can break the link between the SeraMag and DNA capture beads. The beads are returned to the magnet, and the supernatant removed. This wash is repeated three additional times to ensure removal of all null capture beads. To remove the annealed enrichment primers and SeraMag beads from the DNA capture beads, the beads are resuspended in 1 mL of melting solution, vortexed, flicked, or inverted for 5 seconds, and pelleted with the magnet. The supernatant, containing the enriched beads, is transferred to a separate 1.5 mL microcentrifuge tube, the beads pelleted and the supernatant discarded. The enriched beads are then resuspended in 1× Annealing Buffer with 0.1% Tween-20. The beads are pelleted on the MPC again, and the supernatant transferred to a fresh 1.5 mL tube, ensuring maximal removal of remaining SeraMag beads. The beads are centrifuged, after which the supernatant is removed, and the beads washed 3 times with 1 mL of 1× Annealing Buffer. After the third wash, 800 μL of the supernatant are removed, and the remaining beads and solution transferred to a 0.2 mL PCR tube.

In certain embodiments, these steps of enrichment of the beads are optimized to remove substantially every bead that is not bound to template DNA. In certain embodiments, every unbound bead is separated from every bound bead. In certain embodiments, every bead of the remaining beads produces a useful read in a subsequent sequencing reaction. In certain embodiments, substantially every bead of the remaining beads is used to produce a useful read in a subsequent sequencing reaction. In certain embodiments, substantially every bead means 100%, 99.99%, 99.95% 99.9%, 99%, 97%, 95%, 90%, or 85%, or another number, precisely or approximately.

In certain embodiments, the enrichment process yields more than 100,000 beads per emulsified reaction, wherein fewer than 2% of them contain a mixture of templates. In certain embodiments, the enrichment steps yield a plurality of beads wherein none of them contain more than one molecule of template DNA. In certain embodiments, the enrichment process yields 195,991 beads per emulsification reaction with approximately 1.4% or fewer of them including a mixture of templates.

In certain embodiments, one round of emPCR amplification produces approximately 200,000 beads with template that give passed reads in a subsequent sequencing reaction, with fewer than 2% of those beads giving mixed reads.

In a preferred embodiment, the above steps produce a large number of beads, each bound to a single molecule of template DNA. All beads bound to no template DNA have been removed in an enriching step, and no beads are bound to more than one molecule of template DNA. In certain embodiments, a ratio of beads to template molecules is 1, is between 0.5 and 1.5, or is between 0.9 and 1.1, or is between 0.99 and 1.01.

1.f. Sequencing Primer Annealing

The enriched beads are centrifuged at 2,000 RPM for 3 minutes and the supernatant decanted, after which 15 μL of annealing buffer and 3 μL of sequencing primer (100 mM SADIF (5′-GCCTCCCTCGCGCCA-3′ SEQ ID NO: 4, IDT Technologies), are added. The tube is then vortexed for 5 seconds, and placed in an MJ thermocycler for the following 4 stage annealing program: 5 minutes at 65° C., decrease by 0.1° C./sec to 50° C., 1 minute at 50° C., decrease by 0.1° C./sec to 40° C., hold at 40°C. for 1 minute, decrease by 0.1° C./sec to 15° C., hold at 15° C.

Upon completion of the annealing program, the beads are removed from the thermocycler and pelleted by centrifugation for 10 seconds, rotating the tube 180.degree., and spun for an additional 10 seconds. The supernatant is discarded, and 200 μL of annealing buffer are added. The beads are resuspended with a 5 second vortex, flicking, or inversion, and the beads pelleted as before. The supernatant is removed, and the beads resuspended in 100 μL annealing buffer, at which point the beads are quantitated with a Multisizer 3 Coulter Counter. Beads can be stored at 4° C. and are stable for at least one week.

1.g. Incubation of DNA beads with Bst DNA Polymerase, Large Fragment and SSB Protein

Bead wash buffer (100 ml) is prepared by the addition of apyrase (Biotage) (final activity 8.5 units/liter) to 1× assay buffer containing 0.1% BSA. The fiber optic slide is removed from picopure water and incubated in bead wash buffer. The previously prepared DNA beads are centrifuged and the supernatant is carefully removed. The beads are then incubated in 1290 μl of bead wash buffer containing 0.4 mg/mL polyvinyl pyrrolidone (MW 360,000), 1 mM DTT, 175 μg of E. coli single strand binding protein (SSB) (United States Biochemicals) and 7000 units of Bst DNA polymerase, Large Fragment (New England Biolabs). The beads are incubated at room temperature on a rotator for 30 minutes.

1.h. Preparation of Enzyme Beads and Micro-Particle Fillers

UltraGlow Luciferase (Promega) and Bst ATP sulfurylase are prepared as biotin carboxyl carrier protein (BCCP) fusions. The 87-amino acid BCCP region contains a lysine residue to which a biotin is covalently linked during the in vivo expression of the fusion proteins in E. coli. The biotinylated luciferase (1.2 mg) and sulfurylase (0.4 mg) are premixed and bound at 4° C. to 2.0 mL of Dynal M280 paramagnetic beads (10 mg/mL, Dynal SA, Norway) according to manufacturer's instructions. The enzyme bound beads are washed 3 times in 2000 μL of bead wash buffer and resuspended in 2000 μL of bead wash buffer.

Seradyn microparticles (Powerbind SA, 0.8 μm, 10 mg/mL, Seradyn Inc) are prepared as follows: 1050 μL of the stock are washed with 1000 μL of 1× assay buffer containing 0.1% BSA. The microparticles are centrifuged at 9300 g for 10 minutes and the supernatant removed. The wash is repeated 2 more times and the microparticles are resuspended in 1050 μL of 1× assay buffer containing 0.1% BSA. The beads and microparticles are stored on ice until use.

1.i. Bead Deposition

The Dynal enzyme beads and Seradyn microparticles are vortexed for one minute and 1000 μL of each are mixed in a fresh microcentrifuge tube, vortexed briefly and stored on ice. The enzyme/Seradyn beads (1920 μl) are mixed with the DNA beads (1300 μl) and the final volume was adjusted to 3460 μL with bead wash buffer. Beads are deposited in ordered layers. The fiber optic slide is removed from the bead wash buffer and Layer 1, a mix of DNA and enzyme/Seradyn beads, is deposited. After centrifuging, Layer 1 supernatant is aspirated off the fiber optic slide and Layer 2, Dynal enzyme beads, is deposited. This section describes in detail how the different layers are centrifuged.

Layer 1. A gasket that creates two 30×60 mm active areas over the surface of a 60×60 mm fiber optic slide is carefully fitted to the assigned stainless steel dowels on the jig top. The fiber optic slide is placed in the jig with the smooth unetched side of the slide down and the jig top/gasket is fitted onto the etched side of the slide. The jig top is then properly secured with the screws provided, by tightening opposite ends such that they are finger tight. The DNA-enzyme bead mixture is loaded on the fiber optic slide through two inlet ports provided on the jig top. Extreme care is taken to minimize bubbles during loading of the bead mixture. Each deposition is completed with one gentle continuous thrust of the pipette plunger. The entire assembly is centrifuged at 2800 rpm in a Beckman Coulter Allegra 6 centrifuge with GH 3.8-A rotor for 10 minutes. After centrifugation the supernatant is removed with a pipette.

Layer 2. Dynal enzyme beads (920 μL) are mixed with 2760 μL of bead wash buffer and 3400 μL of enzyme-bead suspension is loaded on the fiber optic slide as described previously. The slide assembly is centrifuged at 2800 rpm for 10 min and the supernatant decanted. The fiber optic slide is removed from the jig and stored in bead wash buffer until it is ready to be loaded on the instrument.

1.j. Sequencing on the 454 Instrument

All flow reagents are prepared in 1× assay buffer with 0.4 mg/mL polyvinyl pyrrolidone (MW 360,000), 1 mM DTT and 0.1% Tween 20. Substrate (300 μM D-luciferin (Regis) and 2.5 μM adenosine phophosulfate (Sigma)) is prepared in 1× assay buffer with 0.4 mg/mL polyvinyl pyrrolidone (MW 360,000), 1 mM DTT and 0.1% Tween 20. Apyrase wash is prepared by the addition of apyrase to a final activity of 8.5 units per liter in 1× assay buffer with 0.4 mg/mL polyvinyl pyrrolidone (MW 360,000), 1 mM DTT and 0.1% Tween 20. Deoxynucleotides dCTP, dGTP and dTTP (GE Biosciences) are prepared to a final concentration of 6.5 μM, α-thio deoxyadenosine triphosphate (dATP.alpha.S, Biolog) and sodium pyrophosphate (Sigma) are prepared to a final concentration of 50 μM and 0.1 μM, respectively, in the substrate buffer.

The 454 sequencing instrument consists of three major assemblies: a fluidics subsystem, a fiber optic slide cartridge/flow chamber, and an imaging subsystem. Reagents inlet lines, a multi-valve manifold, and a peristaltic pump form part of the fluidics subsystem. The individual reagents are connected to the appropriate reagent inlet lines, which allows for reagent delivery into the flow chamber, one reagent at a time, at a pre-programmed flow rate and duration. The fiber optic slide cartridge/flow chamber has a 250 μm space between the slide's etched side and the flow chamber ceiling. The flow chamber also includes means for temperature control of the reagents and fiber optic slide, as well as a light-tight housing. The polished (unetched) side of the slide is placed directly in contact with the imaging system.

In certain embodiments, a Roche 454 GS Junior is used.

The cyclical delivery of sequencing reagents into the fiber optic slide wells and washing of the sequencing reaction byproducts from the wells is achieved by a pre-programmed operation of the fluidics system. The program is written in a form of an Interface Control Language (ICL) script, specifying the reagent name (Wash, dATP.alpha.S, dCTP, dGTP, dTTP, and PPi standard), flow rate and duration of each script step. Flow rate is set at 4 mL/min for all reagents and the linear velocity within the flow chamber is approximately .about.1 cm/s. The flow order of the sequencing reagents are organized into kernels where the first kernel consists of a PPi flow (21 seconds), followed by 14 seconds of substrate flow, 28 seconds of apyrase wash and 21 seconds of substrate flow. The first PPi flow is followed by 21 cycles of dNTP flows (dC-substrate-apyrase wash-substrate dA-substrate-apyrase wash-substrate-dG-substrate-apyrase wash-substrate-dT-substrate-apyrase wash-substrate), where each dNTP flow is composed of 4 individual kernels. Each kernel is 84 seconds long (dNTP-21 seconds, substrate flow-14 seconds, apyrase wash-28 seconds, substrate flow-21 seconds); an image is captured after 21 seconds and after 63 seconds. After 21 cycles of dNTP flow, a PPi kernel is introduced, and then followed by another 21 cycles of dNTP flow. The end of the sequencing run is followed by a third PPi kernel. The total run time is 244 minutes. Reagent volumes required to complete this run are as follows: 500 mL of each wash solution, 100 mL of each nucleotide solution. During the run, all reagents are kept at room temperature. The temperature of the flow chamber and flow chamber inlet tubing is controlled at 30° C. and all reagents entering the flow chamber are pre-heated to 30° C.

One method of sequencing is pyrophosphate-based sequencing. In pyrophosphate based sequencing sample DNA sequence and the extension primer subjected to a polymerase reaction in the presence of a nucleotide triphosphate whereby the nucleotide triphosphate will only become incorporated and release pyrophosphate (PPi) if it is complementary to the base in the target position, the nucleotide triphosphate being added either to separate aliquots of sample-primer mixture or successively to the same sample-primer mixture. The release of PPi is then detected to indicate which nucleotide is incorporated.

In an embodiment, a region of the sequence product is determined by annealing a sequencing primer to a region of the template nucleic acid, and then contacting the sequencing primer with a DNA polymerase and a known nucleotide triphosphate, i.e., dATP, dCTP, dGTP, dTTP, or an analog of one of these nucleotides. The sequence can be determined by detecting a sequence reaction byproduct, as is described below.

The sequence primer can be any length or base composition, as long as it is capable of specifically annealing to a region of the amplified nucleic acid template. No particular structure for the sequencing primer is required so long as it is able to specifically prime a region on the amplified template nucleic acid. Preferably, the sequencing primer is complementary to a region of the template that is between the sequence to be characterized and the sequence hybridizable to the anchor primer. The sequencing primer is extended with the DNA polymerase to form a sequence product. The extension is performed in the presence of one or more types of nucleotide triphosphates, and if desired, auxiliary binding proteins.

Incorporation of the dNTP is preferably determined by assaying for the presence of a sequencing byproduct. In a preferred embodiment, the nucleotide sequence of the sequencing product is determined by measuring inorganic pyrophosphate (PPi) liberated from a nucleotide triphosphate (dNTP) as the dNMP is incorporated into an extended sequence primer. This method of sequencing, termed Pyrosequencing™ technology (PyroSequencing AB, Stockholm, Sweden) can be performed in solution (liquid phase) or as a solid phase technique. PPi-based sequencing methods are described generally in, e.g., WO9813523A1, Ronaghi, et al., 1996. Anal. Biochem. 242: 84-89, Ronaghi, et al., 1998. Science 281: 363-365 (1998) and USSN 2001/0024790. These disclosures of PPi sequencing are incorporated herein in their entirety, by reference. See also, e.g., U.S. Pat. Nos. 6,210,891 and 6,258,568, each fully incorporated herein by reference.

In a preferred embodiment, DNA sequencing is performed using 454 corporation's (454 Life Sciences) sequencing apparatus and methods which are disclosed in copending patent applications U.S. Ser. No. 10/768,729, U.S. Ser. No. 10/767,779, U.S. Ser. No. 10/767,899, and U.S. Ser. No. 10/767,894—all of which are filed Jan. 28, 2004.

Unless otherwise defined, all technical and scientific terms used herein have the same meaning as commonly understood by one of ordinary skill in the art to which this invention belongs. Commonly understood definition would include those defined in U.S. Ser. No. 60/476,602, filed Jun. 6, 2003; U.S. Ser. No. 60/476,504, filed Jun. 6, 2003; U.S. Ser. No. 60/443,471, filed Jan. 29, 2003; U.S. Ser. No. 60/476,313, filed Jun. 6, 2003; U.S. Ser. No. 60/476,592, filed Jun. 6, 2003; U.S. Ser. No. 60/465,071, filed Apr. 23, 2003; U.S. Ser. No. 60/497,985, filed Aug. 25, 2003; U.S. Ser. No. 10/767,779 filed Jan. 28, 2004; Ser. No. 10/767,899 filed Jan. 28, 2004; U.S. Ser. No. 10/767,894 filed Jan. 28, 2004. All patents, patent applications, and references cited in this application are hereby fully incorporated by reference.

### Example 2

### Single Molecule FGFR3 Assay Development I: Limits of Detection

In order to maximize detection of FGFR3 mutations, the FGFR3 mutation detection assay will be converted to an ultra-deep sequencing platform using the Roche 454 GS Jr. platform (single molecule FGFR3, or smFGFR3), with a sensitivity of 0.1% as a target. The initial steps of the smFGFR3 assay are similar to the existing FGFR3 real-time mutation detection assay. A primary PCR step is carried out using chimeric primers containing a sequence specific portion for amplifying the exons of interest (Exon 7, 10, and 15) along with adapter sequences required for sequencing analysis. The forward primer (Primer A-Key) included, in the 5′ to 3′ direction, a sequencing primer, a library key (TCAG), a multiplex ID barcode (MID), and a template specific sequence. The reverse primer included, in the 5′ to 3′ direction, an emPCR capture site, a library key (TCAG), a MID barcode, and a template specific sequence.

Multiple samples can be incorporated into a single sequencing run by using primers with a unique multiplex ID barcode (“MID”) for each individual.

After the initial PCR amplification, PCR products are purified using AMPure XP magnetic beads (Beckman Coulter), and quantitated using UV spectroscopy with the NanoDrop 2000. All amplicons to be sequenced are then pooled, diluted, and used as template for an emulsion PCR. During emulsion PCR, individual DNA molecules are amplified in an oil-based emulsion droplet, containing all of the required PCR reaction components along with a DNA capture bead, which binds the PCR products. After the emulsion PCR, the oil droplets are broken with a series of alcohol washes, and capture beads containing DNA are purified and used as template for the sequencing reaction.

2.b. Optimizing emPCR of Sequencing Reads:

The specific number of DNA molecules used per DNA capture bead was empirically determined after testing multiple inputs, ranging from 2 DNA molecules per bead to 0.5 DNA molecules per bead.

Two criteria were used to judge the best ratio of DNA molecules to capture beads. The first is the yield of beads after enrichment, and the second is the number of passed sequencing reads along with the % Dot+Mixed reads. The % Dot+Mixed reads represents sequencing reads with more than one template per emPCR capture bead. The yield of enriched beads must be within a small window of the GS Junior Bead Counter.

In these experiments, greater than 1 DNA molecule per bead generated enriched beads above the window in the bead counter (>20% enrichment), which indicates that many of the templates are mixed. A ratio of 0.5 DNA molecules per capture bead generated enriched beads at the lower limit of the window, which may not consistently generate sufficient beads for a sequencing run (500K beads/run). Therefore, we decided on a final concentration of 1 DNA molecule per bead for all future experiments.

2.C. Improving Sensitivity for Sequencing Reaction:

Several additional modifications to the above protocol were made to improve the number of passed filter sequencing reads, and overall run-to-run consistency. The first change was made during the setup for the emulsion PCR. First, amplicon sequencing libraries were heat denatured (94° C. 2 minutes, 4° C. hold) prior to annealing of the emulsion PCR amplification primer (included in kit). It was observed that the addition of this step significantly improved the number of passed sequencing reads. In addition, the amount of amplification primer was also decreased from the suggested 20 ul to 10 ul to decrease the overall amount of amplified DNA that binds to an individual bead during the emPCR step.

Too much PCR product bound to a capture bead can lead to too bright a signal during the pyrosequencing process, which can bleed from one well to the next causing neighboring wells to be called as “failed” reads during post-sequencing data analysis. The addition of this denaturation step and decreased amplification primer, along with standardizing the manner in which washes are carried out during the enrichment of DNA containing capture beads post-emPCR, greatly improved the number of reads, and significantly reduced the % Dot+Mixed reads after sequencing.

In our previous experiments, the maximum number of passed sequencing reads was 83K, with a % Dot+Mixed reads of 6.7%. After making the changes listed above, our number of passed reads typically is 100K or greater, and the % Dot+Mixed reads is <2%. The maximum number of sequencing reads that have been obtained in a single sequencing run was 175,991, with a % Dot+Mixed of 1.48.

2.d. Mutation Detection

In order to test the limits of mutation detection in the GS Jr. system, a single mutation from exon 7 was tested. In all experiments, only exon 7 was amplified during the primary PCR step and carried through to sequencing. Two MID barcodes were used. Exon 7 primers containing MID 1 were used to amplify 100% wild type DNA (Promega genomic DNA, 50 ng input). Exon 7 primers containing MID 2 were used to amplify wild type DNA mixed with low concentrations of a plasmid containing the S249C mutation—the most prevalent FGFR3 mutation found in bladder cancer.

Plasmid containing the S249C mutation was serially diluted and combined with wild-type human genomic DNA to generate a final plasmid concentration of approximately 0.01% in 50 ng of total DNA.

This experiment was repeated twice, with both sequencing runs giving similar results.

Sequencing run #1 yielded 38,967 total passed filter reads for spiked sample with 8 positive reads containing the S249C mutation (0.0205%).

Sequencing run #2 yielded 73,316 total passed filter reads for spiked sample with 32 positive reads containing the S249C mutation (0.0436%).

A flowgram from sequencing experiment #2 (not shown) revealed a positive detection of the S249C mutation (C to G).

The flogram revealed that the normal sequence in the region of this mutation is TCCCC. In the spiked sample, one C nucleotide is replaced with a G nucleotide, altering the sequence to TGCCC. This net difference in nucleotides appeared in the flowgram. Similar results were obtained with mutation spikes into exon 10 and exon 15 amplicons. A final summary of these results is shown in Table 1.

TABLE 1
Summary of Results of Example 2

| | Expected Percent | Exon-specific | Positive | Percent Mutant |
|---|---|---|---|---|
| | Mutation | Reads | Reads | Detected |
| Exon 7 | 0.01% | 38967 | 8 | 0.02% |
| Exon 10 | 0.02% | 56657 | 10 | 0.02% |
| Exon 15 | 0.02% | 26972 | 2 | 0.01% |

2.e. Conclusions/Observations—Limits Of Detection:

With the modifications made to the emulsion PCR step, we were able to consistently achieve >100K passed sequencing reads per experiment with very low percent mixed beads. In addition, using control genomic DNA and spiked in amounts of known mutations, we are able to reproducibly detect mutations less than our original goal of 0.1%.

### Example 3

### Sample Multiplexing and Mutation Detection

3.a. Exon Multiplexing

In order to maximize assay throughput, primers for each FGFR3 exon tested were multiplexed, as done previously for the FGFR3 qPCR assay. Once optimized, the performance of the FGFR3 sequencing primers was compared to the FGFR3 qPCR assay. The smFGFR3 primary PCR amplification performed equivalently to the existing FGFR3 qPCR assay.

In all cases shown above, the slope, error, and efficiency were within the expected ranges for the primary PCR step of the FGFR3 qPCR assay, suggesting that the use of the Roche 454 adapters instead of UPS tails does not negatively impact amplification efficiency.

To test reproducibility and assay variability between the two platforms, a series of genomic DNA replicates were quantitated in the experiment shown above. Five replicates of 2 ng, 4 ng, Eng, and 8 ng were tested, and the average, standard deviation, and % CV were calculated for each. The results are given in Table 2.

TABLE 2
Reproducibility and variability between FGFR3
qPCR and smFGFR3 primary PCR assays.

| FGFR3 qPCR assay | | | | smFGFR3 primary PCR | | | |
|---|---|---|---|---|---|---|---|
| Expected | Observed | Std Dev | % CV | Expected | Observed | Std Dev | % CV |
| 2 ng | 2.17 | 0.29 | 13% | 2 ng | 2.30 | 0.29 | 13% |
| 4 ng | 4.81 | 0.63 | 13% | 4 ng | 4.70 | 0.30 | 6% |
| 6 ng | 6.36 | 0.44 | 7% | 6 ng | 7.16 | 0.55 | 8% |
| 8 ng | 9.04 | 0.26 | 3% | 8 ng | 9.67 | 0.55 | 6% |

In all cases, the observed quantitation for the smFGFR3 assay format overlapped with the FGFR3 qPCR assay. In addition, the observed % CV for all datapoints was comparable. Similar comparisons were also made between multiple barcoded primer pairs, giving similar results (data not shown).

3.b. Mutation Detection—Multiple Sample Format

Using the information from our experiments with mutant DNA spikes, a very low % mutant sample was amplified in multiplex to ensure that detection of this mutant would not be lost when all three FGFR3 exons were sequenced in a single experiment. In this experiment, genomic DNA was spiked with a low percentage of mutant plasmid (Exon 7—S249C), and amplified for all three FGFR3 exons. In addition, a control genomic DNA (without spike) was amplified and sequenced in the same experiment. As shown in Table 3, even when run in multiplex, very low % mutant detection is maintained down to a level of 0.02%.

TABLE 3
Percent mutant detected in multiplex.

| | Expected Percent | Exon-specific | Positive | Percent Mutant |
|---|---|---|---|---|
| | Mutation | Reads | Reads | Detected |
| Exon 7 | 0.004% | 34489 | 6 | 0.02% |
| Exon 10 | 0.00% | 24202 | 0 | 0.00% |
| Exon 15 | 0.00% | 9975 | 0 | 0.00% |

To determine the maximum number of samples that could be assayed in a sequencing run, a single genomic DNA sample containing a known amount of mutant DNA (Exon 7 S249C) was sequenced with varying numbers of control genomic DNA samples. 50 ng of genomic DNA (either spiked or normal control) was amplified with different barcoded smFGFR3 primers, purified, and prepared for sequencing by emulsion PCR. The same spiked sample was sequenced with 3, 5, and 7 normal control DNAs. The results are shown in Table 4.

TABLE 4
Results of assay with 3, 5, and 7 control DNAs representing 4, 6, and 8 patients, respectively.

| | 4 Patients | | | | 6 Patients | | | | | |
|---|---|---|---|---|---|---|---|---|---|---|
| Expected | 0.02% | 0% | 0% | 0% | 0.02% | 0% | 0% | 0% | 0% | 0% |
| % Mutant | | | | | | | | | | |
| Reads per | 21209 | 20875 | 22889 | 20927 | 17820 | 17125 | 18516 | 16312 | 18348 | 18610 |
| sample | | | | | | | | | | |
| Exon 7 | 8802 | 8948 | 9964 | 9500 | 9601 | 10237 | 10735 | 9504 | 12438 | 10557 |
| Reads | | | | | | | | | | |
| +Reads | 11 | 0 | 0 | 0 | 13 | 0 | 0 | 0 | 0 | 0 |
| % Mutant | 0.12% | 0% | 0% | 0% | 0.14% | 0% | 0% | 0% | 0% | 0% |

| | 8 Patients | | | | | | | |
|---|---|---|---|---|---|---|---|---|
| Expected | 0.02% | 0% | 0% | 0% | 0% | 0% | 0% | 0% |
| % Mutant | | | | | | | | |
| Reads per | 15076 | 14531 | 14661 | 13356 | 12987 | 14490 | 14865 | 13839 |
| sample | | | | | | | | |
| Exon 7 | 5085 | 5095 | 4901 | 5042 | 5308 | 4686 | 5604 | 4581 |
| Reads | | | | | | | | |
| +Reads | 7 | 0 | 0 | 0 | 0 | 0 | 0 | 0 |
| % Mutant | 0.14% | 0% | 0% | 0% | 0% | 0% | 0% | 0% |

In all cases, the overall % mutant DNA detected in each spiked sample was similar (0.12%-11 reads; 0.14%-13 reads; 0.14%-7 reads).

3.c. Conclusions/Observations—Sample Multiplexing:

Multiplexing the smFGFR3 primers successfully replicated the performance of the real-time FGFR3 primary PCR both in primer efficiency and quantitation. In addition, we demonstrated the ability to detect very low percentage mutant DNA in multiplex analysis (0.02%) with two samples analyzed in a single experiment. In a follow up experiment, we have shown that the % mutant DNA is preserved with up to 8 individuals sequenced for all three FGFR3 exons in a single sequencing run.

3.d. Summary of FGFR3 Assay Development:

In this report we have shown the optimization of emulsion PCR. Preferred optimizations include: denature template DNA prior to droplet formation; 1 molecule DNA/bead; 10 μl AMP primer (or half of amount called for in GS Junior Manual); and standardized bead washing steps (3 min. incubation, 8 inversions, 3 min incubation).

Further, we have shown the optimization of the primary PCR amplification for smFGFR3 assays. Optimized primer and probe concentrations are shown in Table 5 that model the performance of the FGFR3 qPCR assay.

TABLE 5
Reagent concentrations in FGFR3 tissue qPCR and smFGFR3 assays;
reagents that differ are underlined.

| | FGFR3 tissue qPCR | smFGFR3 assay |
|---|---|---|
| Reagent | Concentration | Concentration |
| Exon 7 F/R primers | 500 nM | 300 nM |
| Exon 7 Probe | 100 nM | 200 nM |
| Exon 10 F/R Primers | 800 nM | 800 nM |
| Exon 10 Probe | 100 nM | 200 nM |
| Exon 15 F/R Primers | 600 nM | 500 nM |
| Exon 15 Probe | 200 nM | 300 nM |
| Enzyme | 1.2 U | 1.2 U |
| dNTPs | 200 μM | 200 μM |

We have demonstrated the detection of rare mutant DNA populations. Our methods can detect or observe below 0.02% mutant DNA in single amplicon sequencing runs as well as multiplex amplification of all three FGFR3 exons. The assays demonstrated preservation of ˜0.1% mutant DNA signal in a single sample while multiplexed with 3, 5, and 7 normal control DNA samples. We have demonstrated the detection of mutant DNA at levels significantly lower (0.02%) than the documented machine specifications (˜1%) as supplied by Roche 454.

What is claimed is:

1. A method for detecting a mutation in a nucleic acid, the method comprising:
forming a plurality of droplets, wherein on average, each droplet comprises a ratio of one nucleic acid template per bead;
amplifying the template in the droplet to produce bead-bound amplicons; and
sequencing at least one amplicon detect a mutation.

2. The method according to claim 1, wherein the droplet is an aqueous droplet surrounded by an immiscible fluid.

3. The method according to claim 2, wherein the immiscible fluid is oil.

4. The method of claim 1, wherein prior to amplifying, the templates are denatured.

5. The method according to claim 1, wherein the amplifying step is conducted with a limiting amount of amplification primers, thereby decreasing an overall amount of amplicon that binds to an individual bead during the amplifying step.

6. The method according to claim 1, wherein the method is performed in the presence of a control genomic DNA.

7. The method according to claim 1, wherein the method is performed in the presence of an artificially introduced amount of nucleic acid comprising a known mutation.

8. The method according to claim 1, wherein prior to sequencing, the droplets are ruptured.

9. The method according to claim 8, wherein prior to sequencing, bead-bound amplicons are separated from remaining components of the droplets.

10. The method according to claim 1, wherein the nucleic acid template is obtained from a sample.

11. The method of claim 10, wherein the sample is blood, sputum, saliva, urine, sweat, tissue, biopsy tissue, or stool.

12. The method of claim 1, wherein prior to the forming step, the method further comprises amplifying the nucleic acid template.

13. The method of claim 1, wherein prior to the forming step, the method further comprises attaching a unique barcode sequence to the template.

14. The method according to claim 1, wherein the nucleic acid template represents the FGFR3 gene.

15. The method according to claim 13, wherein the mutation in the template is indicative of bladder cancer.

16. A method for detecting a mutation in a nucleic acid, the method comprising:
performing an amplification reaction in a plurality of droplets, each droplet comprising nucleic acid templates and beads, wherein the template to bead ratio is such that less than 2% of the beads comprise more than one template after completion of the amplification reaction; and
sequencing at least one amplification product to detect a mutation.

17. The method according to claim 16, wherein the droplet is an aqueous droplet surrounded by an immiscible fluid.

18. The method according to claim 17, wherein the immiscible fluid is oil.

19. The method of claim 16, wherein prior to amplifying, the templates are denatured.

20. The method according to claim 16, wherein the amplification reaction is conducted with a limiting amount of amplification primers, thereby decreasing an overall amount of amplicon that binds to an individual bead during the amplification reaction.

21. The method according to claim 16, wherein the method is performed in the presence of a control genomic DNA.

22. The method according to claim 16, wherein the method is performed in the presence of an artificially introduced amount of nucleic acid comprising a known mutation.

23. The method according to claim 16, wherein prior to sequencing, the droplets are ruptured.

24. The method according to claim 23, wherein prior to sequencing, bead-bound amplification products are separated from remaining components of the droplets.

25. The method according to claim 16, wherein the nucleic acid template is obtained from a sample.

26. The method of claim 25, wherein the sample is blood, sputum, saliva, urine, sweat, tissue, biopsy tissue, or stool.

27. The method of claim 16, wherein prior to the performing step, the method further comprises attaching a unique barcode sequence to the template.

28. The method according to claim 16, wherein the nucleic acid template represents the FGFR3 gene.

29. The method according to claim 28, wherein the mutation in the template is indicative of bladder cancer.
